(19) United States
(12) Patent Application Publication
(10) Pub. No.: US 2008/0095539 A1
(43) Pub. Date: Apr. 24, 2008

(54) Apparatus for Controlling Channel Power Level in a Multi Channel System

(75) Inventors: Ihab E. Khalouf, Allentown, PA (US); Philip Miguelez, Warminster, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/552,398

(22) Filed: Oct. 24, 2006

(51) Int. Cl. H04B 10/04

(52) U.S. Cl. 398/182

(57) ABSTRACT

The present invention allows an operator to individually control the power level of each communication channel in a network without affecting other parameters of the channels. Each optical transmitter contains a voltage controlled variable optical attenuator which is controlled by a microcontroller to attenuate the optical communication signal to a desired level. The operator can adjust each transmitter separately to overcome the variability in the output optical power of each transmitter, the flatness of the WDM component, EDFA flatness, dispersion of the fiber, etc.

### FIELD OF THE INVENTION

The present invention relates to adjusting the power level of a communication channel. More particularly, the present invention relates to adjusting the power level of an individual communication channel in a network.

### BACKGROUND OF INVENTION

Coaxial cable television systems have been in widespread use for many years and extensive networks have been developed. The extensive and complex networks are often difficult for a cable operator to manage and monitor. A typical cable network generally contains a headend which is usually connected to several nodes which provide content to a cable modem termination system (CMTS) containing several receivers, each receiver connects to several modems of many subscribers, e.g., a single receiver may be connected to hundreds of modems. In many instances several nodes may serve a particular area of a town or city.

The hybrid fiber coaxial (HFC) network and CATV market is driving toward highest density transport where multi transmitters, such as quadrature amplitude modulation (QAM) & dense wavelength division multiplexed (DWDM) CATV transmitters, are gathered next to each other. Each transmitter typically transmits at a specific single wavelength channel of the DWDM, e.g., up to 40 wavelengths on the ITU grid with a 100 Ghz (0.8 nm) spacing. All these wavelengths get combined on a single fiber in order to increase fiber usage and reduce cost. Having multiple channels on the same fiber demands a system to provide the user with ability to control the launched optical power level of each channel in order to equalize the multi channel system and to flatten the channels level prior of sending them to the single fiber link.

A typical approach to change channel levels include modifying the bias of the transmission laser. However, this approach also has significant impact on other communication parameters of the optical signals such as the carrier to noise ratio (C/N) and distortion levels, such as Composite Second Order & Composite Triple-Beat (i.e. CSO and CTB).

Typical external optical attenuators attenuate all of the channels provided to a user rather than attenuating channels individually. This often results in some channels being over attenuated and the channel power levels not being the same. Typical optical attenuators are also very expensive, bulky and not always compatible with a transmission laser implementation. Operators often have little precious space to devote to attenuators and technicians often match a less than optimal attenuator with a laser transmitter unit, often resulting in excessive insertion loss, such as due to reflection, often associated with an external attenuator.

### SUMMARY OF INVENTION

An optical transmission unit in accordance with the principles of the inventions, may comprise: a housing containing: a laser providing an optical communication signal; a variable optical attenuator which receives the optical communication signal from the laser; and a microcontroller configured to control the variable optical attenuator to attenuate the optical communication signal to a desired power level.

The optical transmission unit may further comprise a digital to analog converter connected to the microcontroller to convert signals for controlling the variable optical attenuator from digital to analog. The variable optical attenuator may be a voltage controlled variable optical attenuator which may be a mimic micro-electro-mechanical system (MEMS) attenuator.

In the optical transmission, the microcontroller may use a calibrated lookup table to determine voltage levels to provide to the variable optical attenuator to attenuate the optical communication signal to a desired power level. The microcontroller may also receive instructions to change an attenuation level of the variable optical attenuator from a remote user.

In the optical transmission unit, an upstream communication from a network element may indicates a difference between a current power level and desired power level of the communication signal, and the microcontroller may provide instructions to change an attenuation level of the variable optical attenuator based on the difference.

In the optical transmission unit, a detector associated with an optical output of the transmission unit may indicate a difference between a current power level and desired power level of the communication signal, and the microcontroller provides instructions to change an attenuation level of the variable optical attenuator based on the difference.

The microcontroller may change an attenuation level of the variable optical attenuator to obtain a power level which is the same as another communication signal from another optical transmission unit. Alternatively, the optical transmission unit may change an attenuation level of the variable optical attenuator to obtain a power level which is purposely different from other communication channel signals from another optical transmission unit.

In accordance with principles of the invention, a method of controlling a power level of an optical communication channel provided by an optical transmitter may comprise the steps of: determining parameters for controlling a variable optical attenuator contained in the optical transmitter; instructing the variable optical attenuator to attenuate an optical communication signal received from a laser contained in the optical transmitter; and attenuating the optical communication signal to a desired power level.

The method may further comprise the steps of: determining a current power level of the optical communication signal prior to the step of looking up parameters for controlling a variable optical attenuator, wherein the step of instructing the variable optical attenuator instructs the variable optical attenuator to change an attenuation level based on a difference between the current power level of the optical communication signal and a desired power level of the optical communication signal.

In the method, the step of determining a current power level of the optical communication signal may be based on a calculated power level of the optical communication signal within the optical transmitter.

In the method, the step of determining a current power level of the optical communication signal may be based on a detected power level of the optical communication signal on an optical fiber carrying the optical communication signal or a detected power level of the optical communication signal in a node which receives the optical communication signal located remotely from the optical transmitter.

The step of instructing the variable optical attenuator may instruct the variable optical attenuator to change an attenuation level to obtain a power level which is the same as a power level of another communication signal from another optical transmission unit. The step of instructing the variable optical attenuator may instruct the variable optical attenuator to obtain a power level which is purposely different from other communication channel signals from another optical transmission units.

In the method, the step of determining parameters for controlling a variable optical attenuator may include accessing a lookup table to determine a voltage to provide to the variable optical attenuator to attenuate the optical communication signal to a desired level of power.

The method may include receiving instructions from a remotely located user to change the power level of the optical communication signal. The step of attenuating the optical communication signal to a desired power level preferably does not affect other parameters of the optical communication signal.

In accordance with the principles of the invention, a computer readable medium may carry instructions for a computer to perform a method of controlling a power level of an optical communication channel provided by an optical transmitter which may comprise the steps of: determining parameters for controlling a variable optical attenuator contained in the optical transmitter; instructing the variable optical attenuator to attenuate an optical communication signal received from a laser contained in the optical transmitter; and attenuating the optical communication signal to a desired power level.

In the computer readable medium the instructions may further comprise the steps of: determining a current power level of the optical communication signal prior to the step of looking up parameters for controlling a variable optical attenuator, wherein the step of instructing the variable optical attenuator may instruct the variable optical attenuator to change an attenuation level based on a difference between the current power level of the optical communication signal and a desired power level of the optical communication signal.

In the computer readable medium, the step of determining a current power level of the optical communication signal may be based on a calculated power level of the optical communication signal within the optical transmitter.

In the computer readable medium, the step of determining a current power level of the optical communication signal may be based on a detected power level of the optical communication signal on an optical fiber carrying the optical communication signal or a detected power level of the optical communication signal in a node which receives the optical communication signal located remotely from the optical transmitter.

In the computer readable medium, the step of instructing the variable optical attenuator may instruct the variable optical attenuator to change an attenuation level to obtain a power level which is the same as a power level of another communication signal from another optical transmission unit. The step of instructing the variable optical attenuator may instruct the variable optical attenuator to obtain a power level which is purposely different from other communication channel signals from another optical transmission units.

In the computer readable medium, the step of determining parameters for controlling a variable optical attenuator includes accessing a lookup table to determine a voltage to provide to the variable optical attenuator to attenuate the optical communication signal to a desired level of power.

In the computer readable medium, the instructions further comprise the step of receiving instructions from a remotely located user to change the power level of the optical communication signal.

In the computer readable medium, the step of attenuating the optical communication signal to a desired power level preferably does not affect other parameters of the optical communication signal.

Those of skill in the art will appreciate that the present invention allows an operator to individually control the power level of each communication channel in a network without causing degradation to any other electrical or optical parameters of the transmitter. This invention will overcome the variability in the output optical power of each transmitter and the flatness and dispersion of components in the network. An operator may also equalize the power levels of all of the channels received by a user to the same level. This leveling allows an operator to guarantee that all the channels are arriving to the receiver at the same optical level. Further, since the variable optical attenuator is mounted internally to optical transmitter it will be protected from environmental factors by the casing of the optical transmitter. The variable optical attenuator also does not require extra installation space that an external optical modulator would require. The variable optical attenuator can also be properly configured at the time of manufacture of a transmitter which avoids selection of less than an optimally compatible attenuator with a laser by a technician and provides for reduced insertion loss, such as due to reflection, often associated with an external attenuator.

### BRIEF DESCRIPTION OF THE DRAWINGS

The following drawings serve to illustrate the principles of the invention.

FIG. 1 illustrates an exemplary network in which the present invention may operate.

FIG. 2 illustrates an optical transmitter unit in an exemplary communication system.

FIG. 3 illustrates an exemplary optical transmitter in accordance with the invention in greater detail.

FIG. 4 illustrates an exemplary process according to the invention.

### DETAILED DESCRIPTION OF THE INVENTION

The present invention allows an operator to individually control the power level of each communication channel in a network, such as dense wavelength division multiplexed (DWDM) channels, which is an optical technology used to increase bandwidth over existing fiber optics backbones by sending multi channel signals which may have a channel separation of about 0.8 nm, or coarse wave division multiplexed (CWDM) channels, which may have a channel separation of about 20 nm, without affecting other parameters of the channels. For example, the operator preferably may individually control the power level of channels in a directed and/or external modulated CATV 1550 nm transmitter with a system which has user capability to adjust the output optical power of each transmitter to his desired level of output optical power without causing degradation to any other electrical or optical parameters of the transmitter. This invention allows an operator to overcome the variability in the output optical power of each transmitter, the flatness of the WDM component, EDFA flatness, dispersion of the fiber, etc.

The invention may be able to provide more than 10 dB of optical attenuation per DWDM channel transmitter, and this attenuation may be controlled digitally by user interface command panel. All other parameters (electrically and optically) for the channels, such as in a CATV transmitter, should stay in specification limits. With this invention system engineers can level their channel power to their desired level in order to improve system performance.

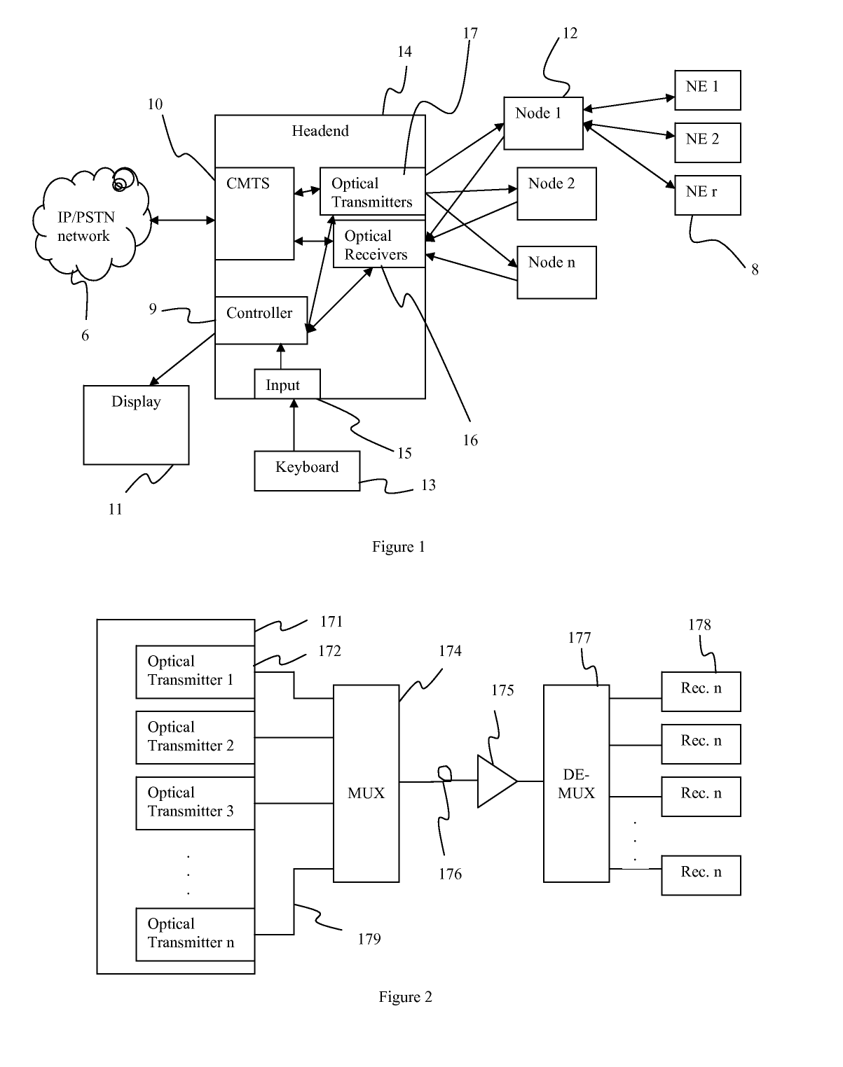

FIG. 1 illustrates an exemplary network in which the present invention may operate. As illustrated in FIG. 1, an exemplary network may include a plurality of terminal network elements 8 (e.g. cable modems, set top boxes, televisions equipped with set top boxes, or any other element on a network such as an HFC network) connected to a cable modem termination system (CMTS) 10 located in a headend 14 through nodes 12 and one or more taps (not shown). In an exemplary arrangement, headend 14 also contains a plurality of optical transmitters 17 which provide downstream optical communications through an optical fiber to the plurality of nodes 12, and an optical receiver 16 which provides upstream optical communications from nodes 12 to the headend 14. The CMTS 10 connects to an IP or PSTN network 6. Those of skill in the art will appreciate that there may be a plurality of nodes 12 connected to a headend, and a headend may contain a plurality of CMTS units, each of which contain a plurality of RF receivers (e.g. 8 receivers) each of which communicate with the optical transmitters 17 and receivers 16 to communicate with a plurality (e.g. 100 s) of network elements 8. Those of skill in the art will also appreciate that optical transmitters 17 and optical receivers 16 are illustrated separately for discussion purposes and may be integrated into one unit.

As illustrated in FIG. 1, a controller 9 allows an operator to control parameters of optical transmitters 17 and optical receivers 16. The operator may provide instructions to controller 9 through input 15 using any conventional techniques, such as with keyboard 13, remotely through a wireline or wireless interface, or through a removable storage device carrying instructions. Input 15 may also include an Ethernet input which allows a remote operator to provide real-time system monitoring and instructions to controller 9. Preferably, controller 9 is configured to determine or receive parameters associated with optical transmitter 17 and optical receiver 16 and provide the parameters to display 11. The operator may view the current power level of a transmission channel on display 11 and provide instructions to change the power level of a particular channel.

FIG. 2 illustrates an optical transmitter unit in an exemplary communication system. Optical transmitter unit 171 may be one of several optical transmitter units contained in optical transmitters 17 of FIG. 1. As illustrated in FIG. 2, optical transmitter unit 171 preferably contains a plurality of optical transmitters 172, each of which transmits an optical signal on a separate frequency (or wavelength) over optical fiber 179 so that each transmitter provides a communication channel to a node 12. The plurality of optical signals are combined together by multiplexer 174 to be carried on a single optical fiber 176 to an erbium doped fiber amplifier (EDFA) and a demultiplexer 177, which may be a distance of 60 Km.

Demultiplexer 177 preferably separates the combined optical signals to provide the respective communication channels to optical receivers 178. Those of skill in the art will appreciate that the optical receivers 178 may be contained in nodes 12, at which point the communication channels may be provided as RF communications signals to network element 8. Alternatively, the receivers 178 may be at the user's premises and an RF conversion of the communication channel may occur at the user's premises prior to network element 8 or within network element 8.

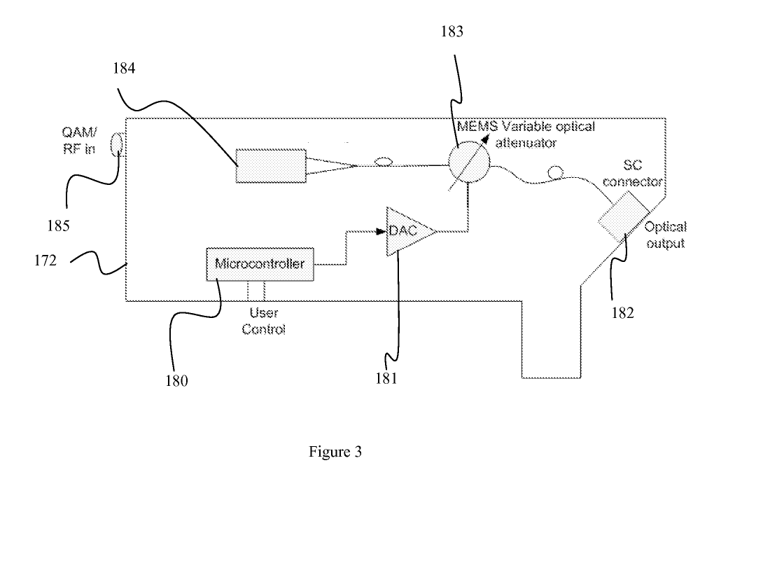

FIG. 3 illustrates an exemplary optical transmitter in accordance with the invention in greater detail. As illustrated in FIG. 3, optical transmitter 172 may be in the form of a card which may be inserted in a slot on optical transmission unit 171. Optical transmitter 172 preferably contains a QAM/RF input 185 which may receive signals from CMTS 10. A laser 184 provides an optical signal at a specified fixed frequency which is modulated to carry the communication signals provided from CMTS 10. Those of skill in the art will appreciate that the laser may be any suitable laser for optical communications, such as a continuous wave (CW) laser which may be directly modulated to provide the communication signal. The optical communication signal from laser 184 is provided to a variable optical attenuator 183, such as a voltage controlled micro-electro-mechanical system (MEMS) variable optical attenuator, such as FVOA 5100 by Lightconnect, Inc. Variable optical attenuator 183 may attenuate the power level of the optical signal prior to being provided to optical output 182, which may be in the form of a SC connector. Variable optical attenuator 183 is preferably voltage controlled and sufficiently small in size to be mounted internally in optical transmitter 172. Variable optical attenuator 183 also preferably provides continuous linear attenuator resolution, such as up to 10 dB dynamic range, and provides small insertion loss.

Optical transmitter 172 preferably contains a microcontroller 180 which may receive instructions from controller 9 (illustrated in FIG. 1) to change the attenuation level of variable optical attenuator 183. Preferably, microcontroller receives a desired power level for the communication channel and accesses a lookup table to determine the appropriate voltage setting to provide to variable optical attenuator 183. The voltage settings are provided to variable optical attenuator 183 through a digital to analog converter (DAC) 181. For example, laser 184 may provide an optical signal with 10 mW of power, but a user may only desire the optical signal to be at 6 mW. Accordingly, microcontroller 180 determines the appropriate voltage levels to provide to variable optical attenuator 183 to attenuate the optical signal to have 6 mW of power.

Since variable optical attenuator 183 is mounted internally to optical transmitter 172, variable optical attenuator 183 will be protected from environmental factors by the casing of optical transmitter 172. variable optical attenuator 183 also does not require extra installation space that an external optical modulator would require. Variable optical attenuator 183 can also be properly configured at the time of manufacture of transmitter 172 which avoids selection of less than an optimally compatible attenuator with laser 184 by a technician and provides for reduced insertion loss, such as due to reflection, often associated with an external attenuator. Variable optical attenuator 183 is also only associated with one optical channel, which allows an operator to uniquely attenuate the power of each optical channel separately.

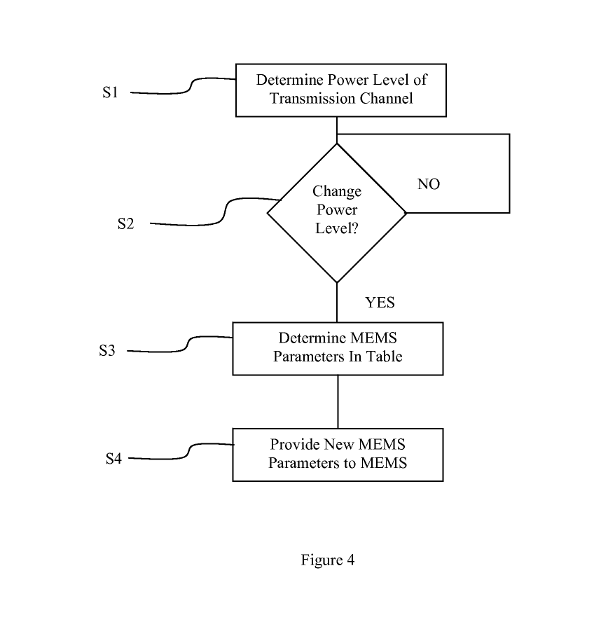

FIG. 4 illustrates an exemplary process according to the invention. As illustrated in FIG. 4, the current power level of a communication channel is determined, step S1. This determination may be made by an operator viewing displayed power levels provided at optical output 182 (FIG. 3) on display 11 (FIG. 1). The power level at output 182 may be empirically determined by microcontroller 180 based on the settings of variable optical attenuator 183 after a calibration process, or by providing a detector to detect the power levels of the optical signals on the optical fiber 179 (P_{f}). The determination of the power levels may be made by a detector in a receiver at node 12 which receives the optical communication signals. A technician may provide the detected power levels to the operator at the headend 14 or the power levels may be automatically reported in an upstream communication signal to the headend 14, such as through an Ethernet port associated with input 15. Those of skill in the art will appreciate that detection of the power levels at a node allows an operator to adjust the power levels to overcome parasitics of the network system, e.g. flatness of the multiplexing components, EDFA flatness, dispersion of the fiber, etc, which may attenuate the optical power. In this manner, the user may be sure to receive the optical signal at the desired power level at the node 12.

As illustrated in FIG. 4, if in the process the power level should be changed, step S2, YES, microprocessor 180 determines the appropriate variable optical attenuator parameters which may be in a look up table, to determine the appropriate voltage to provide to variable optical attenuator 183 to obtain the desired attenuation, step S3. The parameters are provided to variable optical attenuator 183 through DAC 181, step S4. If the power level is not to be changed, step S2, NO, then no action is taken.

The determination to change the power level may be made by an operator based on differences between the current power level and the desired power level. The determination to change the power level may also be performed automatically by controller 9 or microcontroller 180 by instructions from a remotely located operator, such as an operator located at the node, or by using a measured power level either at the optical output 182 or node 12, as a feedback signal to determine differences between the current power level and the desired power level. The adjustment of the power level of a channel may occur with channel setup, maintenance, or routine monitoring, or on a periodic, e.g. weekly, daily, or hourly basis.

An operator may also equalize the power levels of all of the channels received by a user to the same level. This may be accomplished by an operator viewing the power levels for each channel provided to a user, such as to a node, and individually adjusting the power levels of each channel so that they all have the same power level. Alternatively, controller 9 may receive measurements of the power levels of each of the plurality of channels from node 12 or from a detector provided at optical output 182, and individually control the power level of each channel so that all of the channels have the same power level. This leveling is important in order to guarantee that all the channels are arriving to the receiver at the same optical level and to overcome the variability in the output optical power of each transmitter. Alternatively, based on the optical communication system design, those of skill in the art might desire to set the power level of each channel (P_{f}) different in power level from other channels in order to overcome engineering challenges of using fiber optics in multi channel communications.

The processes in FIG. 4 may be implemented in hard wired devices, firmware or software running in a processor. A processing unit for a software or firmware implementation may include either controller 9 and microcontroller 180 or both of them in communication with each other. Instructions to perform any of the processes illustrated in FIG. 4 may be contained on a computer readable medium which may be read by microprocessor 301. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Those of skill in the art will appreciate that the present invention allows an operator to individually control the power level of each communication channel in a network without causing degradation to any other electrical or optical parameters of the transmitter. This invention will overcome the variability in the output optical power of each transmitter, the flatness of the WDM component, EDFA flatness, dispersion of the fiber, etc. An operator may also equalize the power levels of all of the channels received by a user to the same level. This leveling allows an operator to guarantee that all the channels are arriving to the receiver at the same optical level. Further, since variable optical attenuator 183 is mounted internally to optical transmitter 172, variable optical attenuator 183 will be protected from environmental factors by the casing of optical transmitter 172. Variable optical attenuator 183 also does not require extra installation space that an external optical modulator would require. Variable optical attenuator 183 can also be properly configured at the time of manufacture of transmitter 172 which avoids selection of less than an optimally compatible attenuator with laser 184 by a technician and provides for reduced insertion loss, such as due to reflection, often associated with an external attenuator.

What is claimed is:

1. An optical transmission unit comprising:
a housing containing:
a laser providing an optical communication signal;
a variable optical attenuator which receives the optical communication signal from the laser; and
a microcontroller configured to control the variable optical attenuator to attenuate the optical communication signal to a desired power level.

2. The optical transmission unit of claim 1, further comprising a digital to analog converter connected to the microcontroller to convert signals for controlling the variable optical attenuator from digital to analog.

3. The optical transmission unit of claim 1, wherein the variable optical attenuator is a voltage controlled variable optical attenuator.

4. The optical transmission unit of claim 3, wherein the variable optical attenuator is a micro-electro-mechanical system attenuator.

5. The optical transmission unit of claim 3, wherein the microcontroller uses a lookup table to determine voltage levels to provide to the variable optical attenuator to attenuate the optical communication signal to a desired power level.

6. The optical transmission unit of claim 1, wherein the microcontroller receives instructions to change an attenuation level of the variable optical attenuator from a remote user.

7. The optical transmission unit of claim 1, wherein an upstream communication from a network element indicates a difference between a current power level and desired power level of the communication signal, and the microcontroller provides instructions to change an attenuation level of the variable optical attenuator based on the difference.

8. The optical transmission unit of claim 1, wherein a detector associated with an optical output of the transmission unit indicates a difference between a current power level and desired power level of the communication signal, and the microcontroller provides instructions to change an attenuation level of the variable optical attenuator based on the difference.

9. The optical transmission unit of claim 1, wherein the microcontroller changes an attenuation level of the variable optical attenuator to obtain a power level which is the same as another communication signal from another optical transmission unit.

10. The optical transmission unit of claim 1, wherein the microcontroller changes an attenuation level of the variable optical attenuator to obtain a power level which is purposely different from other communication channel signals from another optical transmission units.

11. A method of controlling a power level of an optical communication channel provided by an optical transmitter comprising the steps of:
determining parameters for controlling a variable optical attenuator contained in the optical transmitter;
instructing the variable optical attenuator to attenuate an optical communication signal received from a laser contained in the optical transmitter; and
attenuating the optical communication signal to a desired power level.

12. The method of claim 11, further comprising the steps of:
determining a current power level of the optical communication signal prior to the step of looking up parameters for controlling a variable optical attenuator,
wherein the step of instructing the variable optical attenuator instructs the variable optical attenuator to change an attenuation level based on a difference between the current power level of the optical communication signal and a desired power level of the optical communication signal.

13. The method of claim 12, wherein the step of determining a current power level of the optical communication signal is based on a calculated power level of the optical communication signal within the optical transmitter.

14. The method of claim 13, wherein the step of determining a current power level of the optical communication signal is based on a detected power level of the optical communication signal on an optical fiber carrying the optical communication signal or a detected power level of the optical communication signal in a node which receives the optical communication signal located remotely from the optical transmitter.

15. The method of claim 12, wherein the step of instructing the variable optical attenuator instructs the variable optical attenuator to change an attenuation level to obtain a power level which is the same as a power level of another communication signal from another optical transmission unit.

16. The method of claim 12, wherein the step of instructing the variable optical attenuator instructs the variable optical attenuator to obtain a power level which is purposely different from other communication channel signals from another optical transmission units.

17. The method of claim 11, wherein the step of determining parameters for controlling a variable optical attenuator includes accessing a lookup table to determine a voltage to provide to the variable optical attenuator to attenuate the optical communication signal to a desired level of power.

18. The method of claim 11, further comprising the step of receiving instructions from a remotely located user to change the power level of the optical communication signal.

19. The method of claim 11, wherein the step of attenuating the optical communication signal to a desired power level does not affect other parameters of the optical communication signal.

20. A computer readable medium carrying instructions for a computer to perform a method of controlling a power level of an optical communication channel provided by an optical transmitter comprising the steps of:
determining parameters for controlling a variable optical attenuator contained in the optical transmitter;
instructing the variable optical attenuator to attenuate an optical communication signal received from a laser contained in the optical transmitter; and
attenuating the optical communication signal to a desired power level.

21. The computer readable medium of claim 20, wherein the instructions further comprise the steps of:
determining a current power level of the optical communication signal prior to the step of looking up parameters for controlling a variable optical attenuator,
wherein the step of instructing the variable optical attenuator instructs the variable optical attenuator to change an attenuation level based on a difference between the current power level of the optical communication signal and a desired power level of the optical communication signal.

22. The computer readable medium of claim 21, wherein the step of determining a current power level of the optical communication signal is based on a calculated power level of the optical communication signal within the optical transmitter.

23. The computer readable medium of claim 22, wherein the step of determining a current power level of the optical communication signal is based on a detected power level of the optical communication signal on an optical fiber carrying the optical communication signal or a detected power level of the optical communication signal in a node which receives the optical communication signal located remotely from the optical transmitter.

24. The computer readable medium of claim 21, wherein the step of instructing the variable optical attenuator instructs the variable optical attenuator to change an attenuation level to obtain a power level which is the same as a power level of another communication signal from another optical transmission unit.

25. The computer readable medium of claim 21, wherein the step of instructing the variable optical attenuator instructs the variable optical attenuator to obtain a power level which is purposely different from other communication channel signals from another optical transmission units.

26. The computer readable medium of claim 20, wherein the step of determining parameters for controlling a variable optical attenuator includes accessing a lookup table to determine a voltage to provide to the variable optical attenuator to attenuate the optical communication signal to a desired level of power.

27. The computer readable medium of claim 20, wherein the instructions further comprise the step of receiving instructions from a remotely located user to change the power level of the optical communication signal.

28. The computer readable medium of claim 20, wherein the step of attenuating the optical communication signal to a desired power level does not affect other parameters of the optical communication signal.
